(19) United States
(12) Patent Application Publication
(10) Pub. No.: US 2006/0057547 A1
(43) Pub. Date: Mar. 16, 2006

(54) Electronic motivational apparatus and related methods

(76) Inventor: Timothy Patrick Donley, St. Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/941,482

(22) Filed: Sep. 15, 2004

(51) Int. Cl. G09B 19/00

(52) U.S. Cl. 434/236

(57) ABSTRACT

An electronic motivational apparatus includes a clock module that provides a signal representing time of day. The apparatus also includes a plurality of message modules, each associated with a plurality of messages. A selector module, based on the clock module signal, selects a message module and one of the messages associated with the selected message module. A sound module delivers the selected message.

### FIELD OF THE INVENTION

The present invention relates to audio devices and, more particularly, to an electronic apparatus that provides motivational messages.

### BACKGROUND OF THE INVENTION

For many people who go to a daily job, responding to an alarm clock is an unavoidable way of beginning the workday. A variety of alarm clocks are available which provide a variety of alarm tones and/or automatic radio activation as an alarm. A person awakening from deep sleep, however, frequently finds it unpleasant to awaken to the sound of a buzzer or radio broadcast.

Generally, alarm clocks are seen by many to represent an unpleasant aspect of life in a hurried, distracting and time-constrained world. In such a world, many people turn, for example, to meditation, prayer or motivational methods to retain a sense of direction, tranquility and/or centeredness in their lives. It would be desirable to be able to have one's thoughts turned in such a direction while being awakened in the morning.

### SUMMARY OF THE INVENTION

The present invention, in one configuration, is directed to an electronic motivational apparatus including a clock module that provides a signal representing a time of day. The apparatus also includes a plurality of message modules, each message module associated with a plurality of messages. A selector module, based on the signal of the clock module, selects a message module and one of the messages associated with the selected message module. A sound module delivers the selected message.

In another configuration, an electronic motivational apparatus includes a date-keeping module that that provides a signal representing a calendar date. The apparatus also includes a plurality of message modules, each message module associated with a plurality of messages. A selector module, based on the signal of the date-keeping module, selects a message module and one of the messages associated with the selected message module. A sound module delivers the selected message.

In another implementation, a method for motivating a user is performed by an electronic motivational apparatus. The method includes receiving inputs representing a chosen time and a chosen one of a plurality of message modules of the apparatus. A selector module of the apparatus is activated at the chosen time. The method also includes selecting the chosen message module and one of a plurality of messages associated with the chosen message module, the selecting performed using the activated selector module, and delivering the selected message, the delivering performed using a sound module of the apparatus.

In another implementation, a method of regularly providing motivational messages to a user includes receiving a play time chosen by the user. Depending on a chronological setting, at least one motivational verbal message is selected from a plurality of thematically related motivational verbal messages. The selected message is played at the play time.

In another configuration, the invention is directed to an electronic motivational apparatus for delivering a date-dependent inspirational message. The apparatus includes a display that displays a date and a plurality of compact disks. Each compact disk includes a plurality of motivational verbal messages. A selector device, based on the date, selects one of the compact disks and one of the messages included on the selected disk for play.

In yet another implementation, the invention is directed to a method of obtaining regular delivery of motivational messages. A timer of an electronic motivational apparatus is set to activate a selector module of the apparatus at a predetermined time of day. The method includes choosing one of a plurality of message modules of the apparatus for activation by the selector module at the predetermined time of day, the chosen message module including a plurality of messages, and at the predetermined time of day, listening to one of the messages selected by the selector module based on a calendar date.

The foregoing apparatus allows a user to select a particular and personalized motivation for getting out of bed, be it religious, philosophical or practical. The user can select a motivational impetus from a plurality of motivational themes based on what best works for that individual user. Thus, for example, if the user is religious, he or she may select religious passages to hear upon awakening.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a frontal view of an electronic motivational apparatus in accordance with one configuration of the present invention;

FIG. 2 is a flow diagram of a method of motivating a user using a motivational apparatus in accordance with one implementation of the present invention; and

FIG. 3 is a flow diagram of a method of selecting a message in accordance with one implementation of the present invention.

### DETAILED DESCRIPTION OF EMBODIMENTS

The following description of various embodiments is merely exemplary in nature and is in no way intended to limit the invention, its application, or uses. As used herein, the term module and/or device refers to an application specific integrated circuit (ASIC), an electronic circuit, a processor (shared, dedicated, or group) and memory that execute one or more software or firmware programs, a combinational logic circuit, or other suitable components that provide the described functionality.

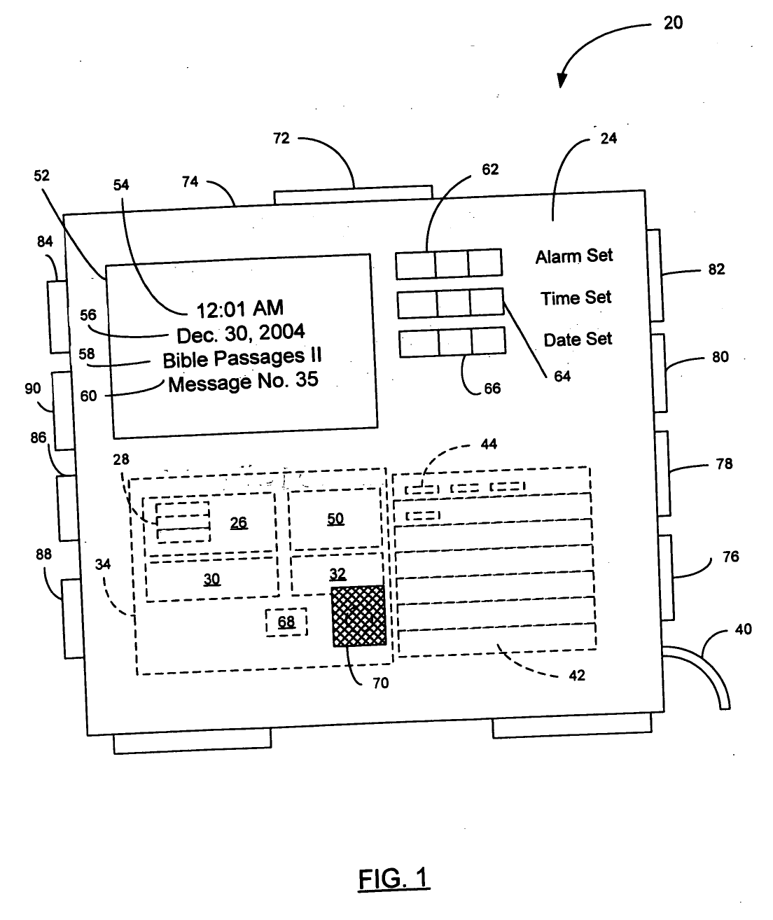

Referring now to FIG. 1, an electronic motivational apparatus in accordance with one configuration of the present invention is indicated generally by reference number 20. The apparatus 20 includes a front face 24. A clock module 26 and other elements of the apparatus 20 behind the front face 24 are indicated in phantom. Generally, the arrangement of elements of the apparatus 20 relative to one another as shown in FIG. 1 are exemplary only, and it should be understood that other arrangements, and alternative and/or additional elements, are possible in other configurations.

The clock module 26 provides a signal representing a time of day. The apparatus 20 also includes one or more timing modules 28, for example, in the clock module 26. The apparatus 20 also can include a date-keeping module 30 that provides a signal representing a calendar date. In another configuration, a single module can provide both time-of-day and date signals. In the present configuration, the date-keeping module 30, clock module 26 and a sound module 32 are included in a processing chip 34. The chip 34 includes one or more processors, memory unit(s) and/or other circuitry configured and/or programmable for performing various functions of the apparatus 20 as described herein. Other configurations are contemplated, however, wherein various elements of the apparatus 20 may be provided on more than one chip. The apparatus is electrically powered via a power source 40, for example, through an electrical connection to a wall outlet. In another configuration, the apparatus 20 could be battery-powered.

The apparatus 20 includes a plurality of message modules 42, each associated with a plurality of messages 44 (four of which are shown in FIG. 1) stored in the apparatus 20. In one configuration, each message module 42 may include a compact disk (CD) or other memory device in which the associated messages 44 are stored. In another configuration, messages 44 may be associated with a message module 42, for example, via an indexing means stored in the apparatus 20. Thus a given message module 42 and message 44 may be associated by various means, even though the associated message 44 may not be stored with other messages associated with the given message module 42 in the same CD or other device. It should be understood that the message modules 42 may be configured in many other or additional ways, including but not limited to configuration in connection with an MP3 player, flash memory device, non-volatile and/or volatile memory in connection with a processor, etc. Based on the time-of-day signal of the clock module 26, a selector module 50 selects a message module 42 and one of the messages 44 associated with the selected message module for delivery by the sound module 32 as further described below.

All of the messages 44 associated with a particular message module 42 preferably are thematically related. For example, such messages may relate to a religion or religious outlook, a motivational method, a philosophy, humor, a recovery program (e.g., a “twelve step” program), a horoscope program, a child-appropriate theme (which may or may not be religious in nature) or other theme. It can be appreciated that a variety of themes can be included in such messages, including but not limited to those mentioned above. A message module 42 may be associated with, for example, three hundred sixty-five (or three hundred sixty-six) messages, i.e., a number of messages sufficient for the apparatus 20 to provide a different message for each day of a calendar year. A daily message could be, for example: “Today is Jan. 17, 2005. Your goal for today is to try to listen more and talk less. Be slow to speak, slow to anger, and eager to listen. It is better to remain silent and let someone think you are a fool than to open your mouth and remove all doubt. . . .” It also is contemplated that a given message could be delivered more than once a year, and that a message module 42 could be associated with fewer than (or more than) three hundred sixty-five messages 44. In one configuration, one or more message modules 42 may be associated with messages appropriate for delivery in connection with a snooze alarm function as further described below.

The apparatus 20 includes a display 52 which may be, for example, a liquid crystal display (LCD) or light-emitting diode (LED). On the display 52 may be displayed a time of day 54 signaled by the clock module 26 and a calendar date 56 (e.g., a month, day and year) signaled by the date-keeping module 30. A name 58 of a message module 42 chosen by a user and a message identifier 60 of a message 44 currently selected as further described below, also may be displayed. One or more buttons or other setting device(s) 62 located, e.g., on the face 24, may be used to set one or more of the timing modules 28 to activate delivery of a message and/or alarm as further described below.

One or more buttons or other setting device(s) 64 may be used to set the clock module 26 (and, accordingly, the time of day display 52) to a particular time of day. One or more buttons or other setting device(s) 66 may be used to set the date-keeping module 30 (and, accordingly, the calendar date display 56) to a particular date. An alarm beeper module 68 (“beeper”) also is included which may be timed and activated to provide a repeated alarm sound (e.g., beeps or other sound). The beeper module 68 may or may not be included in the sound module 32. The beeper 68 may be activated in connection with motivational message delivery as further described below. A speaker 70 may be included in the sound module 32.

A snooze alarm button 72 may be available on a top surface 74 of the apparatus 20. The apparatus 20 also includes a message module selector device 76, a message selector device 78, a “favorite” message switch 80, and a snooze alarm activator 82. The apparatus 20 also may include an “instant replay” activator 84, a “repeat” activator 86, and a “continuous play” activator 88.

A “mode” selector 90 may be activated to select from a plurality of modes of operation of the apparatus 20. For example, an alarm mode may be selected to cause the apparatus to operate as an alarm clock. Specifically, when the alarm mode is selected, the alarm beeper 68 may be activated by a timing module 28 set via setting device(s) 62. In one configuration, when the alarm mode is selected, only the alarm beeper 68 is activated; that is, no messages are played.

A radio mode may be selected to cause a radio (not shown) to be played upon actuation by a timing module 28 set via setting device(s) 62. Similarly, a CD mode may be selected to cause a CD (which may or may not be a message module 42) to be played. The “mode” selector 90 also may provide for selection of a message mode, in which the apparatus may operate as described herein to deliver a message 44. The display 52 may display various elements and features dependent on which mode is selected. The alarm beeper 68 may or may not be activated in various modes. For example, a user may select not to activate the alarm beeper 68 while the apparatus 20 operates in radio mode. It can be appreciated that various modes may be configured in many different ways to include and/or not include many various features. It can be clearly understood that the various buttons, activators, selectors, etc. of the apparatus 20 also could be configured in many different ways and could be located relative to various and different surfaces of the apparatus in other configurations.

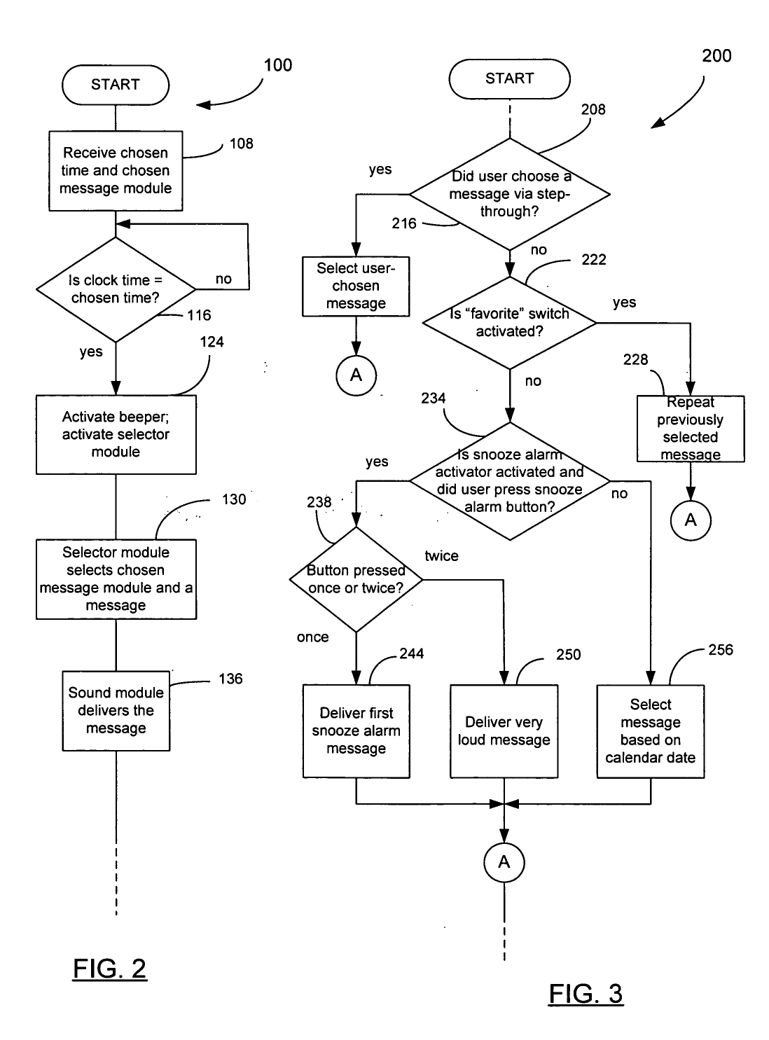

The apparatus 20 may be used to perform a method for motivating a user indicated generally in FIG. 2 by reference number 100. Generally, to prepare the apparatus 20 for use, a user activates the message module selector device 76 to choose one of the message modules 42. Thus the user may select from among modules 42 associated, for example, with Zen sayings, Bible scriptures, Twelve-Step recovery, and/or motivation toward success. The user uses the setting device(s) 62 to set one or more of the timing modules 28 to activate the selector module 50 at one or more times of day chosen by the user. For example, the user may set a timing module 28 to activate the selector module 50 at a time in the morning at which the user wishes to awaken. Additionally or alternatively, the user may set a timing module 28, for example, to activate the selector module 50 near bedtime, at a time at which it is desired to hear a message. Thus, at step 108 of the method 100, the apparatus 20 receives inputs representing a chosen time and a chosen message module 42.

When a timing module 28 is set by the user to a chosen time, at step 116 the chosen time is compared with the time signal of the clock module 26. If at step 116 the clock module time signal matches the chosen time, at step 124 the alarm beeper 68 may be activated for a predetermined time, after which the selector module 50 is activated. At step 130 the selector module 50 selects the chosen message module 42 and a message 44 associated with the chosen message module 42. The selector module 50 may select a message, for example, that is associated by the apparatus 20 with the calendar date as signaled by the date-keeping module 30. As further described below, the selector module 50 may select a message 44 at step 130 in various ways, and selection based on calendar date is only one such possible way. At step 136, the message selected by the selector module 50 is delivered via the sound module 32. The sound module 32 may include a sound card or other sound-producing capability and may deliver messages in a plurality of aural forms, including but not limited to human speech, music, a foghorn as described below, and/or other types of sounds.

In one configuration, the user may use the message selector device 78 to choose from the chosen message module 42 a desired message 44, e.g., a message that is not associated with a current calendar date. For example, where the message selector device 78 is configured to provide a “step-through” function, the user may use the device 78 to step through calendar dates until a date associated with the desired message is reached. The user may use the device 78 to choose the desired message, which subsequently is selected by the selector module 50 at a chosen time for delivery by the sound module 32. It also is contemplated that the user may search a module 42 by date or by message number to select a message

The selector device 78 may also be configured to allow the user to select a message 44 based on a category. That is, the user may select a message 44 from a group of messages based on a particular theme, e.g., encouragement, prayer, holiday, forgiveness, resourcefulness, etc.

In one configuration, the user may activate the “favorite” message switch 80 to cause a selected message 44 to be repeatedly selected at one or more subsequent activations of the selector module 50. Thus a message 44 may be repeated, until the switch 80 is deactivated. When a message has been selected by the selector module 50 (for example, based on a calendar date, or as chosen by the user using the message selector device 78 as previously described), the user may activate the “favorite” message switch 80 to cause the selected message to be repeatedly selected by the selector module 50. The user subsequently may deactivate the “favorite” message switch to cause the selector module 50 to resume selecting a message based on calendar date. Thus the user can hear a favorite message more than once, e.g., for days, weeks, months or for as long as desired, and then resume hearing messages associated with current calendar dates.

The “instant replay” activator 84 can be activated by the user, for example, at any time to immediately activate the selector module 50 and sound module 32 to again deliver the last-selected and delivered message 44. Thus the user can hear a message again after its delivery without having to set a timing module 28 to activate the selector module 50. The “repeat” activator 86 can be activated by the user, for example, to cause the sound module 32 to repeatedly deliver the last-delivered message 44 until the “repeat” activator is deactivated, or, in another configuration, until the message 44 has been repeated for a predetermined number of repetition times. The “continuous play” activator 88 causes the selector module 50 to continuously select messages associated with a selected message module 42 and the sound module 32 to continuously deliver such messages. The selector module 50 may be activated to select such messages in a random order or in a predetermined order. Thus, for example, a user can listen not only to one, but to a plurality of different messages 44 while the selector module 50 is activated.

In one configuration, a snooze alarm function may be activated by pressing the snooze alarm activator 82. When such function is activated and the sound module 32 delivers a message 44 as previously described, the user may press the snooze alarm button 72 to stop delivery of the message. As soon as the button 72 is pressed, the selector module 50 selects a message module 42 associated with snooze alarm-related messages 44. The selector module 50 selects such a message, for example, “If you snooze, you lose!” or other motivational message. Such messages, for example, could be humorous and/or insulting to motivate a snoozing user to awaken. If the user presses the snooze alarm button 72 a second time, the selector module 50 may select a very loud snooze alarm-related message 44, e.g., one that sounds like a foghorn. The sound module 32 may deliver the loud message continuously for an extended time period, for example, until the apparatus is disconnected from the power source 40. In one configuration, when the apparatus 20 subsequently is reconnected to the power source 40, the selector module 50 selects, and the sound module 32 delivers, a follow-up message 44 that says, for example, “I bet you don't do that again!” or the like.

One exemplary implementation of a method that utilizes several elements described in the foregoing discussion is indicated generally in FIG. 3 by reference number 200. The method 200 may be implemented by the selector module 50, for example, in selecting a message at step 130 of the method 100. In the method 200, at step 208 it is determined whether the user has chosen a message associated with a selected message module 42, for example, whether the user has used a “step-through” function, as previously described, to choose a particular message 44. If yes, then at step 216 the selector module 50 selects the particular message chosen by the user. If it is determined at step 208 that a particular message has not been chosen, control passes to step 222. At step 222, it is determined whether the “favorite” switch 80 is activated. If yes, then at step 228 the selector module 50 selects the same message 44 it selected in an immediately previous activation. If at step 222 it is determined that the “favorite” switch 80 is not activated, control passes to step 234.

At step 234 it is determined whether the snooze alarm activator 82 is activated and whether the user has pressed the snooze alarm button 72. If it is determined that the snooze alarm activator 82 is activated and the snooze alarm button 72 was pressed, then at step 238 it is determined whether the snooze alarm button 72 was pressed once or twice. If once, then at step 244 the selector module 50 selects a snooze-alarm-related motivational message, for example, “If you snooze, you lose” (or the like). If at step 238 it is determined that the snooze alarm button 72 was pressed twice, then at step 250 the selector module 50 selects a “foghorn” message (or the like) as previously described. If at step 234 it is determined that the snooze alarm activator 82 is not activated and/or the user did not press the snooze alarm button 72, then at step 256 the selector module 50 uses the calendar date signal from the date-keeping module 30 to select, based on calendar date, a message 44 associated with the selected message module 42.

In one configuration, a user may select a “normal snooze mode” that causes a selected message to be replayed after a predetermined time period, for example, after nine minutes. It also is contemplated that a user could activate, for example, a 20-second alarm clock wakeup followed by a seven-play cycle of the selected message 44, with a 30-second silence in between plays. In another configuration, a “reminder beep” may sound to remind a user to listen to a message 44. For example, when the user activates the snooze alarm button 72 after an initial alarm beep but before the message 44 is played, a reminder beep occurs, e.g., every two minutes until the user causes the beeping to stop and/or the message to be played.

The selector module 50 may be configured to select a message module 42 and/or message 44 associated with the selected message module 42 according to a predetermined rotation order. A rotation order can be defined in various ways. For example, at each activation of the selector module 50, the selector module 50 may select a different message associated with a message module 42 until all messages 44 associated with that message module have been delivered. The selector module 50 then could select a second message module 42 and select each message 44 associated with the second message module 42, and so on, until all message modules 42 are selected and all messages 44 are delivered. (It is contemplated that message modules 42 associated with snooze alarm messages 44 could be omitted from such rotations.) According to another rotation order, the selector module 50 could select fewer than all messages associated with a given message module 42, e.g., every other message 44, before selecting another message module 42. It should be understood that the order in which messages 44 and message modules 42 may be selected may be varied in many different ways. It also is contemplated that additional and alternative switches, activators and selector devices may be provided to allow a user to choose from among various additional or alternative rotation orders of the apparatus 20.

In one configuration of the apparatus 20, a plurality of message modules 42 may each relate to the same theme. Thus the user can hear messages relating to a single desired theme and can hear and/or select a message 44 from a wide variety of messages. Alternatively or additionally, the apparatus 20 may include message modules 42 relating to more than one theme, and two or more of the modules 42 can be rotated automatically as previously described.

The foregoing apparatus and related methods make it possible for a user to fit devotional and/or motivational time into the busiest of days. The apparatus makes it possible for the user not only to awaken to a daily motivational message, but also to play the daily message, and/or a different message, at any time during the day or night. Time that might otherwise be wasted can be transformed by the apparatus into the most valuable time of the day. The apparatus allows a user to consistently find time to take part in devotional or motivational activity. Because the messages and motivation can change with the days of the year, the user can be encouraged through the daily messages to take note of and appreciate the changing seasons. The apparatus also can provide “heavier” doses of motivation for the user who knows that he or she will tend to shut off a “snooze” button to an excessive degree.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electronic motivational apparatus comprising:
a clock module that provides a signal representing a time of day;
a plurality of message modules, each message module associated with a plurality of messages;
a selector module that, based on the signal of the clock module, selects a message module and one of the messages associated with the selected message module; and
a sound module that delivers the selected message.

2. The apparatus of claim 1, further comprising one or more timing modules, each configurable to activate the selector module based on the signal of the clock module.

3. The apparatus of claim 1, further comprising a date-keeping module that provides a signal representing a calendar date, and wherein the selector module is configured to select a message based on the signal of the date-keeping module as well as on the signal of the clock module.

4. The apparatus of claim 1, wherein the selector module is further configured to select, based on user input, at least one of a message module and a message associated with the selected message module.

5. The apparatus of claim 4, wherein the selector module selects a message associated with a calendar date or message number selected by the user.

6. The apparatus of claim 4, wherein the selector module repeatedly selects a message based on user input.

7. The apparatus of claim 1, wherein all of the messages associated with at least one of the message modules are thematically related.

8. The apparatus of claim 7, wherein the theme relating the messages comprises at least one of a religion, a religious outlook, a motivational method, a philosophy, humor, a recovery program, a horoscope program, a child-appropriate theme and a snooze alarm function.

9. The apparatus of claim 1, wherein the selector module is further configured to select, according to a predetermined rotation order as well as based on the signal of the clock module, at least one of a message module and a message associated with the selected message module.

10. An electronic motivational apparatus comprising:
a date-keeping module that that provides a signal representing a calendar date;
a plurality of message modules, each message module associated with a plurality of messages;
a selector module that, based on the signal of the date-keeping module, selects a message module and one of the messages associated with the selected message module; and
a sound module that delivers the selected message.

11. The apparatus of claim 10, further comprising a clock module that provides a signal representing a time of day, the selector module further configured to select a message module based also on the signal of the clock module.

12. The apparatus of claim 11, further comprising one or more timing modules, each configurable to activate the selector module based on the signal of the clock module.

13. The apparatus of claim 10, the selector module further configured to select at least one of a message module and a message associated with a selected message module based on user input.

14. The apparatus of claim 13, wherein the selector module selects a message associated with a calendar date selected by the user.

15. The apparatus of claim 13, wherein the selector module selects a message previously selected by the selector module.

16. The apparatus of claim 10, wherein the messages associated with one of the message modules are thematically related.

17. The apparatus of claim 16, wherein thematically related comprises relating to at least one of a religion, a religious outlook, a motivational method, a philosophy, humor, a recovery program, a horoscope program, and a child-appropriate theme.

18. The apparatus of claim 10, wherein the selector module is further configured to select, according to a predetermined rotation order, at least one of a message module and a message associated with a selected message module.

19. The apparatus of claim 10, wherein the selector module further selects a snooze-alarm-related message in response to activation of a snooze alarm function of the apparatus.

20. A method for motivating a user, the method performed by an electronic motivational apparatus and comprising:
receiving inputs representing a chosen time and a chosen one of a plurality of message modules of the apparatus;
activating a selector module of the apparatus at the chosen time;
selecting the chosen message module and one of a plurality of messages associated with the chosen message module, the selecting performed using the activated selector module; and
delivering the selected message, the delivering performed using a sound module of the apparatus.

21. The method of claim 20, wherein activating the selector module at the chosen time comprises comparing the chosen time with a signal representing a time of day, said comparing performed using a timing module of the apparatus.

22. The method of claim 20 wherein selecting one of a plurality of messages comprises selecting one of a plurality of messages based on a signal representing a calendar date provided by a date-keeping module of the apparatus.

23. The method of claim 20, wherein the messages associated with the chosen message module are thematically related.

24. The method of claim 20, wherein delivering the selected message comprises delivering a message relating to at least one of a religion, a religious outlook, a motivational method, a philosophy, humor, a recovery program, a horoscope program, and a child-appropriate theme.

25. The method of claim 20, further comprising selecting and delivering a message associated with a snooze alarm function of the apparatus.

26. A method of regularly providing motivational messages to a user, the method comprising:
receiving a play time chosen by the user;
depending upon a chronological setting, selecting at least one motivational verbal message from a plurality of thematically related motivational verbal messages; and
playing the selected message at the play time.

27. An electronic motivational apparatus for delivering a date-dependent inspirational message, the apparatus comprising:
a display that displays a date;
a plurality of compact disks, each compact disk including a plurality of motivational verbal messages; and
a selector device that, based on the date, selects one of the compact disks and one of the messages included on the selected disk for play.

28. The apparatus of claim 27, further comprising an alarm that can be set to a play time; wherein the selector device selects the one of the compact disks and the one of the messages for play at the play time.

29. A method of obtaining regular delivery of motivational messages, the method comprising:
setting a timer of an electronic motivational apparatus to activate a selector module of the apparatus at a predetermined time of day;
choosing one of a plurality of message modules of the apparatus for activation by the selector module at the predetermined time of day, the chosen message module including a plurality of messages; and
at the predetermined time of day, listening to one of the messages selected by the selector module based on a calendar date.
